(19) United States
(12) Patent Application Publication
(10) Pub. No.: US 2009/0150980 A1
(43) Pub. Date: Jun. 11, 2009

(54) Management Control of Assets

(75) Inventor: Craig Gregory Smith, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: ARGUS SOLUTIONS PTY LTD, Milsons Point (AU)

(21) Appl. No.: 10/563,452

(22) PCT Filed: Jul. 2, 2004
(86) PCT No.: PCT/AU04/00880

§ 371 Date: Jul. 6, 2007

(30) Foreign Application Priority Data
Jul. 3, 2003 (AU) 2003903392

(51) Int. Cl. G06K 9/00; H04L 9/00; G06F 17/30; G06F 15/00

(52) U.S. Cl. 726/5

(57) ABSTRACT

Methods and systems for managing the issue or return of secure assets are disclosed. The methods and systems use biometric identification for assured security.

### CROSS REFERENCE TO RELATED APPLICATIONS

This application is a U.S. National Phase of International Application No. PCT/AU2004/000880, filed Jul. 2, 2004, which claims the benefit of Australian Application No. 2003903392, filed Jul. 3, 2003, the specifications of which are herein incorporated by reference in their entirety.

### TECHNICAL FIELD

This invention concerns a computerized identity matching management process for regulating the issue of secure assets. The invention further concerns a computerized identity matching management process for regulating the return of secure assets. In addition the invention concerns a computerized identity matching management system for regulating the issue of, or the return of, secure assets. Finally the invention concerns an electronic message for transmission by a biometric capture apparatus during a computerized identity matching process.

### BACKGROUND ART

The concept of iris recognition. was developed and patented by Iridian Technologies Inc, and their concept patent U.S. Pat. No. 4,641,349 describes the use of the iris to identify individuals. U.S. Pat. No. 5,291,560 describes a method by which a biometric, including the iris pattern of an individual, can be used as the basis of an identification technique.

Argus Solutions Pty Ltd, developed a computerized identity matching management process and associated system. Their patent application PCT/AU02/01579 describes managing the provision of identity matching services, for instance to enable users to gain appropriate access to service provider's facilities. The essence of that invention is the time limit imposed on the period between the issue of the unique code which initiates the capture process, and the receipt of the biometric coded with the code. The same code is only ever issued once. This time limit is determined according to the time required for the capture process, and serves to reduce the possibility of the introduction of a false biometric. For instance a time limit of ninety seconds has been found to be suitable when an iris biometric is to be captured.

### SUMMARY OF CERTAIN INVENTIVE ASPECTS

In a first aspect, the invention is a computerized identity matching management process for regulating the issue of secure assets, the process comprising the steps of:

identifying an asset having a unique classification identifier;

identifying an issuer of the asset and a receiver of the asset, each comprising the steps of:

a management computer receiving a request, from capture apparatus waiting to commence a capture process of a biometric representative of the issuer of the asset or the receiver of the asset, to initiate the capture process;

the management computer responding to the request by returning a message to the capture apparatus, the message containing a unique code and receipt of the message containing the code at the capture apparatus causing initiation of the capture process;
the capture apparatus encoding a captured biometric representative of the issuer of the asset or representative of the receiver of the asset with the code;
the management computer, after returning the message, receiving the encoded captured biometric; and
the management computer decoding the captured biometric and initiating a matching process to find a match for the decoded captured biometric against stored records and generating an identification code representative of the issuer of the asset or representative of the receiver of the asset when a match is found;
retrieving a privilege of the receiver to determine whether the receiver's privilege matches the asset classification identifier and, if a match is determined
issuing the asset and recording information to form a use record relating to the issue of the asset.

The step of the management computer returning the message to the capture apparatus may occur at a first instance in time. The management computer may receive the encoded captured biometric at a second instance in time, and the management computer may operate to decode the encoded captured biometric and initiate the matching process only when the second instance is less than a predetermined time interval later than the first instance.

An asset is defined as a physical item of value or interest. For instance, the assets may include, but are not limited to, firearms, weapons, batons, pharmaceutical medications and products, narcotics, precious metals and legal documents.

The receiver's privilege determines the type of assets which the receiver is authorized to receive.

The unique identifier is a means of being able to identify each particular asset. In one example each asset may be uniquely identified by a barcode. In another example each asset may be uniquely identified by a radio frequency identifier. The unique identifier may be a machine-readable. The unique identifier, such as a barcode, may be tamper-proof and may be securely attached to, or imprinted directly onto, or into, the asset. In such an instance the identifier may be identified by scanning the barcode. The invention is not limited to these examples.

The method may further include generating an alert if the receiver's privilege does not match the asset classification.

In a second aspect, the invention is a computerized identity matching management process for regulating the return of secure assets, the process comprising the steps of:

identifying an asset having a unique classification identifier;

identifying a receiver who seeks to return the asset, comprising the steps of:

a management computer receiving a request, from capture apparatus waiting to commence a capture process of a biometric representative of the receiver who seeks to return the asset, to initiate the capture process;

the management computer responding to the request by returning a message to the capture apparatus, the message containing a unique code and receipt of the message containing the code at the capture apparatus causing initiation of the capture process;

the capture apparatus encoding a captured biometric representative of the receiver of the asset with the code;

the management computer, after returning the message, receiving the encoded captured biometric; and

the management computer decoding the captured biometric and initiating a matching process to find a match for the decoded captured biometric against stored records and generating an identification code representative of the receiver when a match is found;

retrieving a receiver's privilege to determine whether the receiver's privilege matches the asset classification identifier and, if a match is determined

retrieving the asset from the receiver and recording information to form a use record relating to the retrieval of the asset.

The process according to the second aspect may also comprise the step of identifying an issuer of assets to whom the asset is returned, comprising the steps of:

the management computer receiving a request, from capture apparatus waiting to commence a capture process of a biometric representative of the issuer, to initiate the capture process;

the management computer responding to the request by returning a message to the capture apparatus at a first instant in time, the message containing a unique code and receipt of the message containing the code at the capture apparatus causing initiation of the capture process;

the capture apparatus encoding a captured biometric representative of the issuer of the asset with the code;

the management computer, after returning the message, receiving the encoded captured biometric; and

the management computer decoding the captured biometric and initiating a matching process to find a match for the decoded captured biometric against stored records and generating an identification code representative of the issuer when a match is found.

In a third aspect, the invention is a computerized identity matching management system for regulating the issue of, or the return of, secure assets, comprising:

a data depository to store records of assets each having a unique asset classification identifier and a record of receivers and receivers' privileges;

an asset identifier for identifying the asset to be issued or to be returned;

a computer programmed to:

receive a request, from capture apparatus waiting to commence a capture process of a biometric, to initiate the capture process to identify a receiver who is requesting the issue of an asset or the return of an asset;

respond to the request to return a message to the capture apparatus, the message containing a unique code, and where receipt of the message containing the code at the capture apparatus causes initiation of the capture process;

after returning the message, receive a captured biometric from the capture apparatus encoded with the code; and

to decode the captured biometric;

an authentication server to perform a matching process to find a match for the decoded captured biometric against stored records and to generate an identification code representative of the receiver who is requesting the issue of an asset or the return of an asset when a match is found, the server further retrieving the receiver's privilege to determine whether the receiver's privilege matches the asset classification identifier, and if a match is determined forming a use record relating to the issue of the asset or the return of the asset.

In an example of the second or third aspects, the step of the management computer returning the message to the capture apparatus may occur at a first instance in time. The management computer may receive the encoded captured biometric at a second instance in time, and the management computer operating to decode the encoded captured biometric and initiate the matching process only when the second instance is less than a predetermined time interval later than the first instance.

The computer may be further programmed to identify an issuer of assets.

The record of the assets use may include the date and time that the asset was issued by the issuer and received by the receiver. The record of the assets use may further include the date and time that the issuer received the asset which the receiver returned.

The computer may be programmed further such that if a match is determined a message is able to be generated authorizing the release of the asset to the receiver.

The computer may be programmed further such that if a match is not determined the issuer is alerted.

In one example the asset identifier is a radio frequency reader for identifying the asset to be issued or to be returned. In another example the asset identifier is a barcode reader for identifying the asset to be issued or to be returned.

In a fourth aspect the invention is an electronic message for transmission from a biometric capture apparatus to a computer during a computerized identity matching process for regulating the issue of an asset or the return of an asset, the electronic message comprising a captured image of a potential receiver of the asset, the captured image encoded with the unique code obtained from the computer.

### BRIEF DESCRIPTION OF DRAWINGS

An example of the system will now be described with reference to the accompanying drawings; in which:

FIG. 1 is a schematic diagram of a system in accordance with an embodiment of the invention which is used to regulate the issue of and the return of secure assets;

FIG. 2 is a flow chart showing a process for regulating the issue of secure assets, in accordance with an embodiment of the invention; and

FIG. 3 is a flow chart showing a process for regulating the return of secure assets, in accordance with an embodiment of the invention.

### DETAILED DESCRIPTION OF CERTAIN INVENTIVE EMBODIMENTS

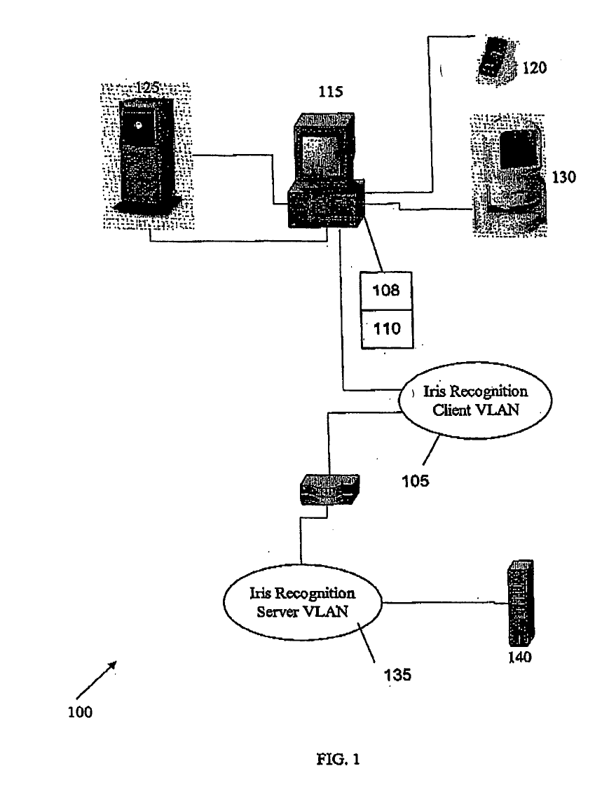

FIG. 1 illustrates a system 100 used to regulate the issue of and the return of secure assets. The system 100 includes an Iris Recognition client computer 105 which is programmed to receive and transmit messages through a firewall and over the Internet to client software 108. The client software 108 resides in a PC 115. The client software 108 works with identification software 110 and an iris recognition camera 120 which includes a special lens to photograph the eye. Alternately, the client software 108 may work with identification software 110 and an imager 125. An iris recognition server 135 accepts the iris image which is sent from the camera 120. In addition, it confirms the image integrity and then sends it through an iris recognition process for verification against records stored in its cache which in turn is drawn from a secure database 140.

The database 140 stores asset information, issuer information, receiver information, a rights table and an asset log. The issuer information includes for each issuer:
a ‘name field’,
‘iriscode template fields’ for the left and right eye of the issuer, and
a ‘create date field’.

The receiver information in addition includes a ‘privilege field’.

The asset information includes for each asset ID:
an ‘asset name field’
a ‘create date field’
an ‘asset type field’ and
an ‘asset classification field’.

The asset log information includes for each draw sequence #:
an ‘issuer ID’
a ‘receiver ID’,
a ‘time in field’ and
a ‘time out field’

The software 110, works with a barcode reader 130 which is used to scan a secure asset for release or alternatively for its return.

In this example, the components of the system 100 are installed on site at an armoury. The armoury stores secure assets such as firearms. Each firearm stored in the armoury has a unique machine-readable, non-removable identification in the form of a barcode.

The PC 115 is accessed by dispatching officers who have the authorization to release assets in and out of the armoury. The camera 120 is used to capture an iris image of a dispatching officer when the officer is on duty and responsible for the release of firearms from the armoury. The camera 120 also operates to capture an image of a receiving officer each time the officer wishes to draw one or more firearms from the armoury and similarly when the officer returns the firearms to the armoury.

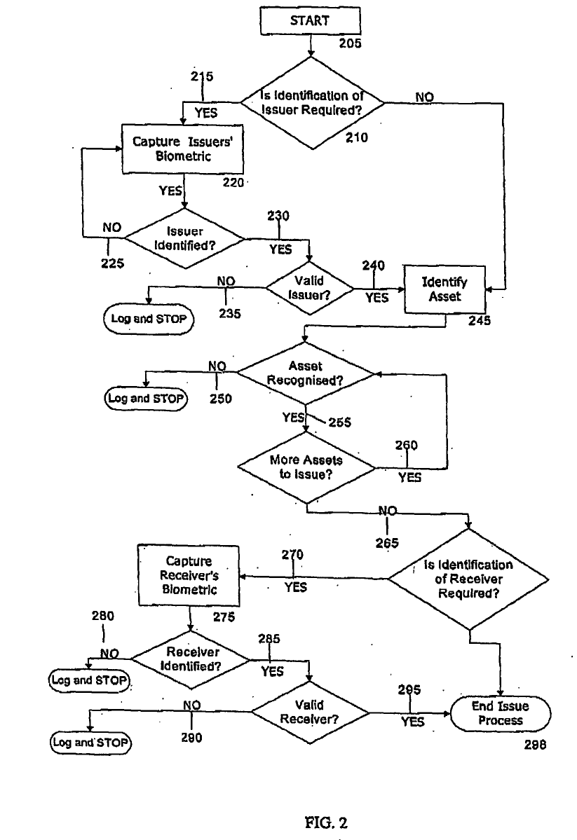

FIG. 2 illustrates an example of the steps which can be taken when a firearm is requested for release. The dispatching officer starts a session 205. The system is launched and checks whether identification of the dispatching officer is required 210. In the event that biometric identification is requested 215, the client software 108 is launched and captures the Private ID software 110 to take control of the camera 120 so as to record an image of the dispatching officer's right and left irises, step 220.

The client software 108 sends a message to the client computer 105 for a message authentication code (MAC). The client computer 105 responds to the request and issues a MAC.

The MAC is valid for a preset period of time and is unique (i.e.: is only ever issued once). The time at which the MAC is issued is embedded in the MAC.

The client software 108 receives the MAC and the identification software 110 commences capture of the dispatching officer's iris.

To use camera 120, the dispatching officer moves his or her head so that the particular eye being photographed is 43-48 cm (17 to 19 inches) from the lens. The camera 120 sends images to the software 110 running on the computer 115.

The identification software 110 captures a series of digital video images of the dispatching officer's eye. Image quality metrics within the identification software 110 inspect the images for sufficient quality and iris content to ensure high confidence for a successful match outcome. Once a satisfactory image has been obtained, the software 110 provides an audible signal to inform the issuer that the image capture session is complete, this usually issues within seconds. If a satisfactory image cannot be captured within the allotted time (the default is set at 10 seconds), then the software provides an error signal. The dispatching officer would then have to restart the process of having images of the iris captured 225.

Once captured, the process of identifying the dispatching officer begins 230. The client software 108 encrypts the captured image using an appropriate cryptographic algorithm. Then it compresses the captured image, codes the compressed image using the previously issued MAC and assembles a message for transmission to the client computer 105.

The client computer 105 receives the message from the client software 108. The client computer 105 checks it for validity using the MAC, that is to ensure it has been received while the MAC is still valid i.e that the time that the client computer 105 receives the message is within the preset period of time to reduce the likelihood of a false biometric being issued. The message then has its integrity checked using a checksum, and is decompressed and decrypted. It is then passed through a Daugman Algorithm, or similar, to create an iriscode.

The iriscode is then sent to the Iris recognition server 135 which attempts to match it with a record in its secure database 140. The ‘iriscode template field’ in the issuer information table is searched. The Iris recognition server 135 returns a result to the client computer 105 which interprets the result. If the result is a comparison failure, that result is logged and the process stops 235.

If a match is found, the result indicates that the dispatching officer is an authorized issuer 240. The process of identifying the firearm which the receiver wishes to borrow is begun 245. The receiving officer has requested a firearm of type A. The dispatching officer retrieves the firearm sought. Embedded in the handle of the firearm is a barcode. The dispatching officer scans the barcode. The client software 108 receives the identification number of the firearm and sends it to the Iris recognition server 135 which attempts to match it with a record in its secure database 140. The ‘asset type field’ in the asset information table is searched.

The Iris recognition server 135 returns a result to the client computer 105 which interprets the result. If the result is a comparison failure, that result is logged and the process stops 250.

If the result is that the firearm is recognized 255 the issuer asks the potential receiving officer whether further firearms are to be issued. If further firearms are required the process of identifying each of the firearms which the receiver officer wishes to borrow is repeated 260.

If no further firearms are sought 265 the process of identifying the receiving officer and the determining whether the receiving officer has the prerequisite rights to borrow the firearm sought is begun 270.

The client software 108 sends a message to the client computer 105 for a MAC. The client 105 responds to the request and issues a MAC. The client software 108 receives the MAC and the identification software 110 commences capture of the receiving officer's iris, in the same manner as the dispatching officer.

The captured receiving officer's iriscode is then sent to the Iris recognition server 135 which attempts to match it with a record in its secure database 140. The ‘iriscode template field’ in the receiver information table is searched. The Iris recognition server 135 returns a result to the client computer 105 which interprets the result.

If the result is that the receiver is not identified, the result is logged and the process stops 280. If the receiving officer is identified then the process continues 285.

The iris recognition server then determines whether the identified receiving officer is entitled to draw the particular firearm requested. The asset classification for the firearm sought is attempted to be matched against the ‘privilege field’ in the receiver information table. If the receiving officer is not authorized to draw that particular firearm, the result is logged and the process stops 290.

If the result is that the receiving officer has the required privilege to draw the particular firearm 295 then the ‘asset log information table’ is written to. Against the particular firearm is written the identification of the dispatching officer, the receiving officer and the date and time of release. The issuing process is then complete and the firearm are released 298.

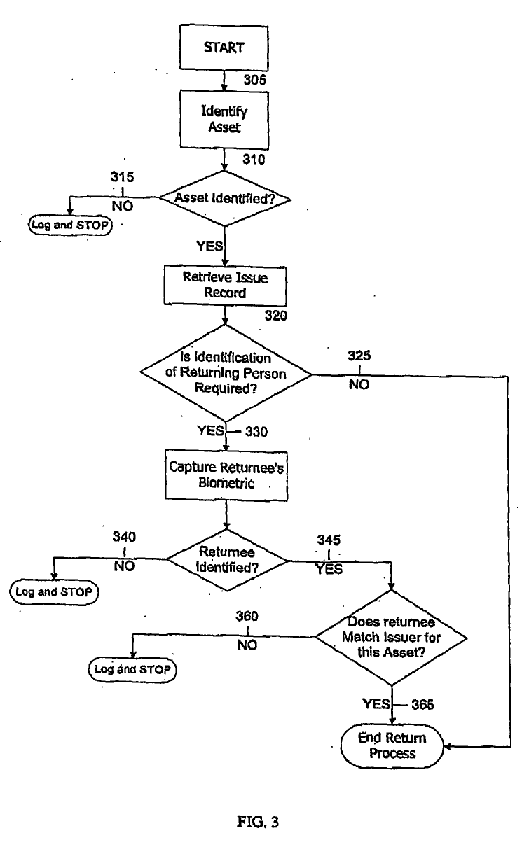

At some later stage the firearm is to be returned to the armoury. FIG. 3 illustrates an example of the steps which can be involved when the receiving officer attempts, referred to now as the ‘returnee’ to return the asset 300. The dispatching officer on duty starts the process 305. The firearm which is being returned is scanned by the dispatching officer 310. If the firearm is not identified the process is logged and stopped 315 and the firearm is left in the possession of the returnee. Having identified the firearm 320 the ‘asset log information table’ of the particular firearm is retrieved from the database 140. If the identity of the returnee is not required 325 then the return process stops 370.

If the identity of the returnee is required 330 the client software 108 is launched and captures the identification software 110 to take control of the camera 120 so as to record an image of the returnee's right and left irises, step 220.

The client software 108 sends a message to the client computer 105 for a message authentication code (MAC). The client 105 responds to the request and issues a MAC. The client software 108 receives the MAC and the identification software 110 commences capture of the returnee's irises. Once captured, the client software 108 encrypts, compresses and codes the captured image and assembles a message for transmission to the client computer 105.

The client computer 105 receives the message and checks it for validity using MAC, that is to ensure it has been received while the MAC is still valid. The message then has its integrity checked using a checksum, and is decompressed and decrypted. It is then passed through a Daugman Algorithm, or similar, to create an iriscode.

The iriscode is then sent to the Iris recognition server 135 which attempts to match it with a record in its secure database 140. The ‘iriscode template field’ in the receiver information table is searched. The Iris recognition server 135 returns a result to the client computer 105 which interprets the result. If the result is that the returnee is not identified, the result is logged and the process stops 340. If the returnee is identified then the process continues 345.

The returnee is then validated against the information in the database 140. The ‘asset log information table’ for the particular firearm is retrieved. The returnee identity is checked to determine a match. If a match is not detected the result is logged and the process stops 360.

If a match is detected 365, then the time out field in the ‘asset log information table’ is written to, the asset is returned to the armoury and the return process is complete 370.

It will be appreciated by persons skilled in the art that numerous variations and/or modifications may be made to the invention without departing from the spirit or scope of the invention. The aspects discussed are, therefore, to be considered in all respects as illustrative and not restrictive.

For example, in an alternative example, the iris recognition client computer, server and database may be secured offsite at a secure premise.

The above example, when describing the issue of an asset, comprises the steps of identifying an issuer of assets, identifying an asset, identifying a receiver of the asset and validating whether the receiver is entitled to draw the asset. It should be appreciated that the invention is not limited to the order in which these steps are performed. Similarly, some steps may be removed and others may be added. Since the issuer checks out each asset, it is not necessary for the issuer to scan his or her iris every time an asset is issued.

1. A computerized identity matching management method for regulating the issue of secure assets, the method comprising:
identifying an asset having a unique classification identifier;
identifying an issuer of the asset; and
identifying a receiver of the asset, wherein identifying the issuer and identifying the receiver each comprise:
a management computer. receiving a request to initiate the capture process from a capture apparatus waiting to commence a capture process of a biometric of the issuer or the receiver;
the management computer responding to the request by returning a message to the capture apparatus, the message comprising a unique code, wherein receipt of the message comprising the code at the capture apparatus causes initiation of the capture process;
the capture apparatus encoding a captured biometric of the issuer or of the receiver;
the management computer, after returning the message, receiving the encoded captured biometric; and
the management computer decoding the captured biometric and initiating a matching process to find a match for the decoded captured biometric against stored records and generating an identification code representative of the issuer or of the receiver of the asset when a match is found;
retrieving a privilege of the receiver to determine whether the privilege matches an an asset classification identifier of the asset; and, if a match is determined
issuing the asset and recording information to form a use record relating to the issue of the asset.

2. The process according to claim 1, wherein the management computer returning the message to the capture apparatus occurs at a first time, the management computer receiving the encoded captured biometric occurs at a second time, and the management computer operating to decode the encoded captured biometric and initiate the matching process only when the second time is less than a time interval later than the first time.

3. The process according to claim 1, further comprising generating an alert if the privilege does not match the asset classification.

4. The process according to claim 1, wherein the assets comprises at least one of firearms, weapons, batons, pharmaceutical medications and products, narcotics, precious metals and legal documents.

5. The process according to claim 1, wherein the unique classification identifier is securely attached to, or imprinted directly onto or into, the asset.

6. The process according to claim 1, wherein the unique classification identifier comprises a barcode.

7. The process according to claim 1, wherein the unique classification identifier comprises a radio frequency identifier.

8. A computerized identity matching management method for regulating the return of secure assets, the method comprising:
identifying an asset having a unique classification identifier;
identifying a receiver who seeks to return the asset, identifying the receiver comprising:
management computer receiving a request to initiate the capture process, from a capture apparatus waiting to commence a capture process of a biometric of the receiver;
the management computer responding to the request by returning a message to the capture apparatus, the message comprising a unique code, wherein receipt of the message comprising the code at the capture apparatus causes initiation of the capture process;
the capture apparatus encoding a captured biometric of the receiver;
the management computer, after returning the message, receiving the encoded captured biometric; and
the management computer decoding the captured biometric and initiating a matching process to find a match for the decoded captured biometric against stored records and generating an identification code representative of the receiver when a match is found;
retrieving a privilege of the receiver to determine whether the privilege matches an asset classification identifier of the asset; and, if a match is determined
retrieving the asset from the receiver and recording information to form a use record relating to the retrieval of the asset.

9. The process according to claim 8, further comprising identifying an issuer of assets to whom the asset is returned, wherein identifying the issuer comprises:
the management computer receiving a request to initiate the capture process, from a capture apparatus waiting to commence a capture process of a biometric of the issuer;
the management computer responding to the request by returning a message to the capture apparatus at a first time, the message comprising a unique code and receipt of the message comprising the code at the capture apparatus causing initiation of the capture process;
the capture apparatus encoding a captured biometric;
the management computer, after returning the message, receiving the encoded captured biometric; and
the management computer decoding the captured biometric and initiating a matching process to find a match for the decoded captured biometric against stored records and generating an identification code representative of the issuer when a match is found.

10. The process according to claim 8, where the management computer returning the message to the capture apparatus occurs at a first time, the management computer receiving the encoded captured biometric occurs at a second time, and the management computer operating to decode the encoded captured biometric and initiate the matching process only when the second time is less than a time interval later than the first time.

11. The process according to claim 8, wherein the assets comprises any one or more of firearms, weapons, batons, pharmaceutical medications and products, narcotics, precious metals, and legal documents.

12. The process according to claim 8, wherein the unique classification identifier is securely attached to, or imprinted directly onto or into, the asset.

13. The process according to claim 8, where the unique classification identifier comprises a barcode.

14. The process according to claim 8, where the unique classification identifier comprises a radio frequency identifier.

15. A computerized identity matching management system for regulating the issue of, or the return of, secure assets, the system comprising:
a data depository configured to store records of assets each asset having a unique asset classification identifier and to store a record of receivers and a privilege for each receiver;
an asset identifier configured to identify the asset to be issued or to be returned;
a computer programmed to:
receive a request to initiate a capture process from a capture apparatus waiting to commence a capture process of a biometric so as to identify a receiver who is requesting the issue of an asset or the return of an asset;
respond to the request by returning a message to the capture apparatus, the message comprising a unique code, wherein receipt of the message comprising the code at the capture apparatus causes initiation of the capture process;
after returning the message, receive a captured biometric from the capture apparatus encoded with the code; and
to decode the captured biometric; and
an authentication server configured to perform a matching process to find a match for the decoded captured biometric against stored records and to generate an identification code representative of the receiver who is requesting the issue of an asset or the return of an asset when a match is found, the server further configured to retrieve the privilege of the receiver to determine whether the privilege matches the asset classification identifier, and if a match is determined to form a use record relating to the issue of the asset or the return of the asset.

16. The process according to claim 15, wherein the management computer returning the message to the capture apparatus occurs at a first time, the management computer receiving the encoded captured biometric occurs at a second time, and the management computer operating to decode the encoded captured biometric and initiate the matching process only when the second time is less than a time interval later than the first time.

17. The system according to claim 15, wherein the computer is further programmed to identify an issuer of assets.

18. The system according to claim 15, wherein the use record of each asset further includes the date and time that the asset was issued by the issuer and received by the receiver.

19. The system according to claim 15, wherein the use record of each asset includes a date and a time that the issuer received the asset.

20. The system according to claim 15, wherein the computer is further programmed such that if a match is determined, a message is generated authorizing the release of the asset to the receiver.

21. The system according to claim 15, wherein the computer is further programmed such that if a match is not determined the issuer is alerted.

22. The system according to claim 15, wherein the asset identifier comprises a radio frequency reader.

23. The system according to claim 15, where the asset identifier comprises a barcode reader.

24. An electronic message for transmission from a biometric capture apparatus to a computer during a computerized identity matching process for regulating the issue of an asset or the return of an asset, the electronic message comprising a captured image of a potential receiver of the asset or a potential returner of the asset, the captured image encoded with a unique code obtained from the computer.
